(19) United States
(12) Patent Application Publication
(10) Pub. No.: US 2006/0251405 A1
(43) Pub. Date: Nov. 9, 2006

(54) Method of tracking predetermined periods of time while encouraging brand loyalty

(76) Inventor: George A. Saleh, Kansas City, MO (US)

Correspondence Address: LATHROP & GAGE LC, 2345 GRAND AVENUE, SUITE 2800, KANSAS CITY, MO, 64108, US

(21) Appl. No.: 11/124,927

(22) Filed: May 9, 2005

(51) Int. Cl. H04N 7/00

(52) U.S. Cl. 386/96

(57) ABSTRACT

A method of tracking predetermined time periods while encouraging brand loyalty comprises steps for: selling consumer a product that requires tracking the time period; providing consumer with audio data having a predetermined timespan corresponding to the time period; instructing consumer to begin playing the audio data at the time period's beginning; and instructing consumer that the audio data's end marks the time period's conclusion. Company may provide consumer with an audio device compatible with the audio data. The audio data preferably includes information pertaining to the product as well as an entertainment selection. Consumer may choose the audio data's content. Preferably, company periodically provides consumer with additional audio data having the predetermined timespan. The product is preferably a pharmaceutical drug prescribed to be taken by consumer at preset intervals and that requires tracking the time period after the drug is ingested for limiting consumer's activities during the time period.

### BACKGROUND OF THE INVENTION

This invention relates generally to a system and method for tracking predetermined periods of time. In particular, the present invention relates to a system and method for signaling a conclusion of a predetermined period of time that also encourages brand loyalty and entertains customers.

In a preferred embodiment, the current invention relates to a system and method for timing periods after a patient has taken a dosage of medication that also encourages brand loyalty and entertains patients.

Some medications are currently on the market that require a patient to stay upright and refrain from eating for a certain period of time after taking the medication, and other such medications are under development. Many of these medications are once-a-week or once-a-month dosages. While studies have shown that only 44% of patients are compliant with their medication, these medications are often less effective and less safe if the directions are not followed. In addition, companies often find it difficult to create brand loyalty to products that are only taken once-a-week or once-a-month.

While various proposals for devices that signal when medication is to be taken may be found in the art, such as in U.S. Pat. Nos. 4,837,719; 5,088,056; and 5,152,422, an enjoyable method or system that times a period after the medication is taken is absent. Moreover, classic wind-up “kitchen timers” and timers such as those found in U.S. Pat. Nos. 6,300,548 and 6,878,914 fail to provide product information or to offer marketing benefits by creating brand loyalty.

### SUMMARY OF THE INVENTION

A method of tracking predetermined periods of time while encouraging brand loyalty according to the present invention comprises steps for: selling a product to a consumer that requires the tracking of the predetermined period of time; providing the consumer with audio data having a predetermined timespan corresponding to the predetermined period of time; indicating that the audio data is provided by the company; instructing the consumer to begin playing the audio data at a beginning of the period of time; and instructing the consumer that an end of the audio data marks the conclusion of the predetermined period of time. The company may also provide the consumer with an audio device on which the audio data may be played and indicate that the audio device is provided to the consumer by the company. The audio data preferably includes information pertaining to the product as well as an entertainment selection, and the consumer may or may not choose the content of the audio data. Preferably, the company periodically provides the consumer with additional audio data having the predetermined timespan.

In a preferred embodiment, the product is a pharmaceutical drug prescribed to be taken by the consumer at preset intervals (such as once-a-week or once-a-month) and that requires the tracking of the predetermined period of time after the drug is ingested for limiting the consumer's activities during the predetermined period of time, such as a half-hour or an hour.

### BRIEF DESCRIPTION OF THE DRAWINGS

FIG. 1 is a flowchart describing the inventive method of tracking predetermined periods of time while encouraging brand loyalty;

FIG. 2 is a diagram showing a company selling a product to a consumer;

FIG. 3 is a diagram showing the predetermined period of time and the predetermined timespan;

FIG. 4 is a diagram as in FIG. 3 for one embodiment of the inventive method;

FIG. 5 is a diagram as in FIG. 3 for another embodiment of the inventive method;

FIG. 6 is a diagram as in FIG. 3 for yet another embodiment of the inventive method; and

FIG. 7 is a diagram showing the audio data to be compatible with the audio device.

### DESCRIPTION OF THE PREFERRED EMBODIMENT

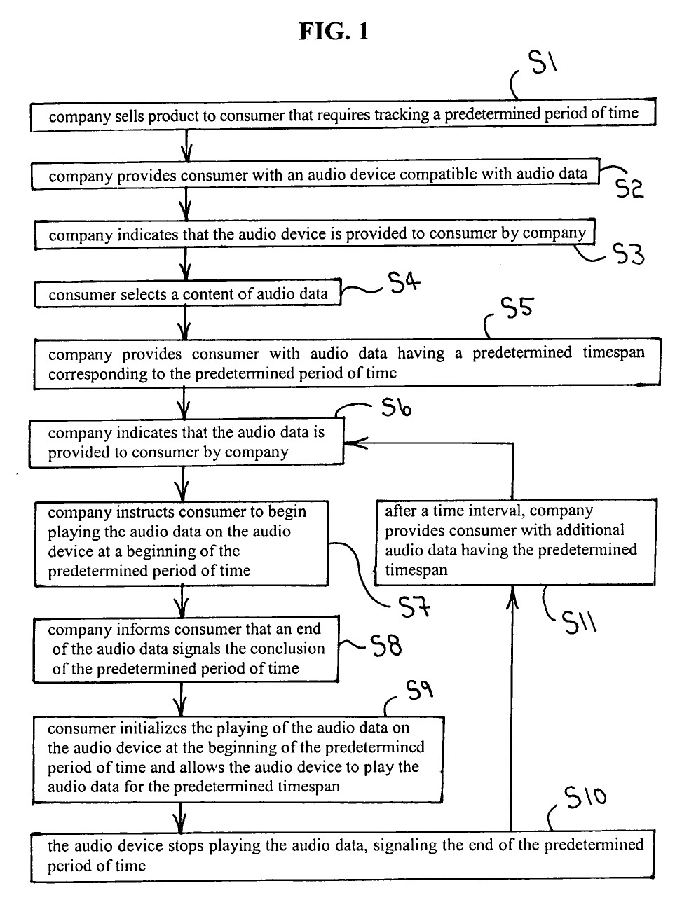

A method for signaling a conclusion of a predetermined period of time while encouraging brand loyalty to a company according to the present invention will now be described in detail with reference to FIGS. 1 through 7 of the accompanying drawings.

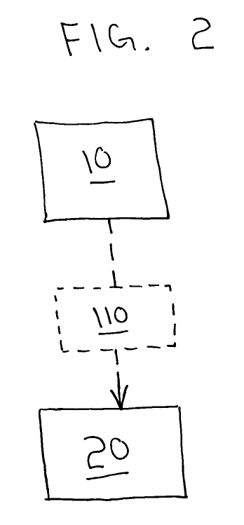

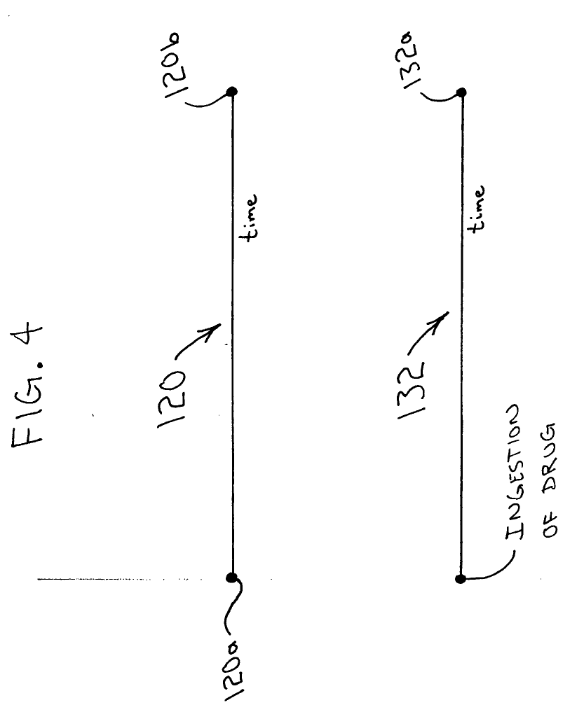

The first step S1 of the current method involves a company 10 selling a product 110 to a consumer 20 that requires the tracking of a predetermined period of time 120 (FIGS. 1 and 2). In a preferred embodiment, the product 110 is a pharmaceutical drug prescribed to be taken by the consumer 20 at preset intervals, such as once-a-week or once-a-month, and that requires the tracking of the predetermined period of time 120 after the pharmaceutical drug is ingested by the consumer 20 for limiting the consumer's activities during the predetermined period of time 120. In this embodiment, a beginning 120a of the predetermined period of time 120 corresponds to when the pharmaceutical drug is ingested by the consumer 10 (FIG. 4). “Company” as used herein includes a manufacturer or distributor of the product 110 as well as their associates.

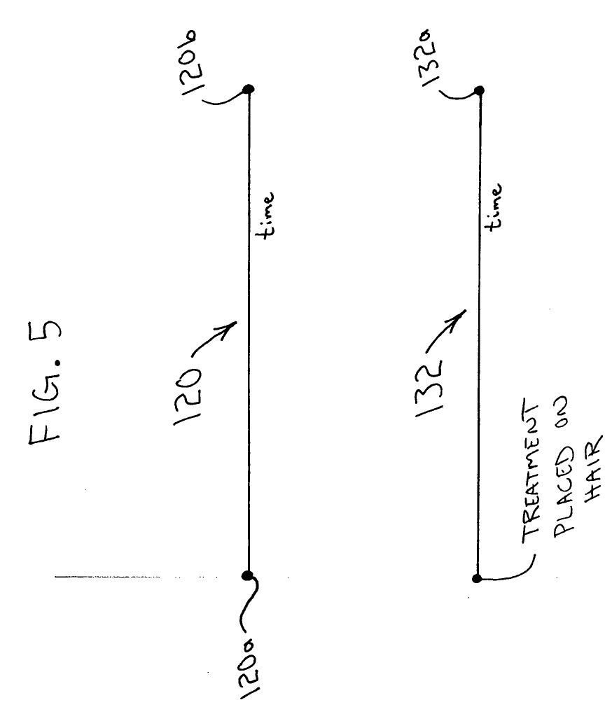

In another embodiment of the current invention, the product 110 is a hair treatment that requires contact with hair for the predetermined period of time 120. For this embodiment, the beginning 120a of the predetermined period of time 120 corresponds to a point in time when the hair treatment is placed on the hair (FIG. 5).

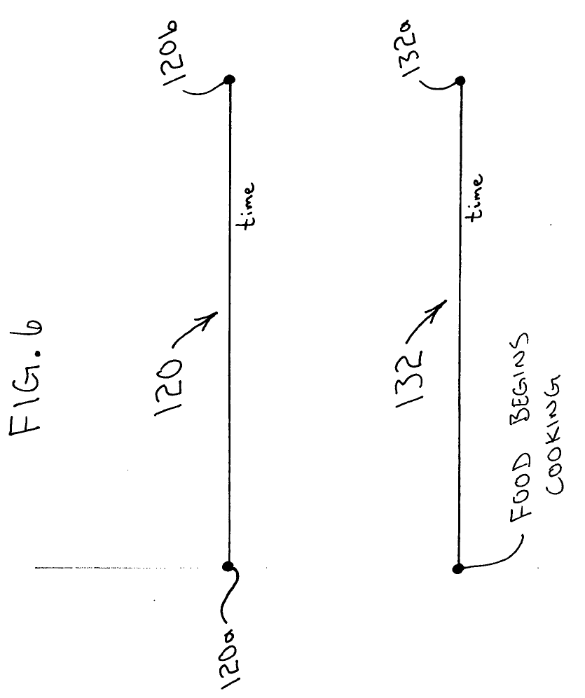

In yet another exemplary embodiment of the current invention, the product 110 is a cookbook that requires cooking food for the predetermined period of time 120. For this embodiment, the beginning 120a of the predetermined period of time 120 corresponds to a point in time when food begins cooking (FIG. 6).

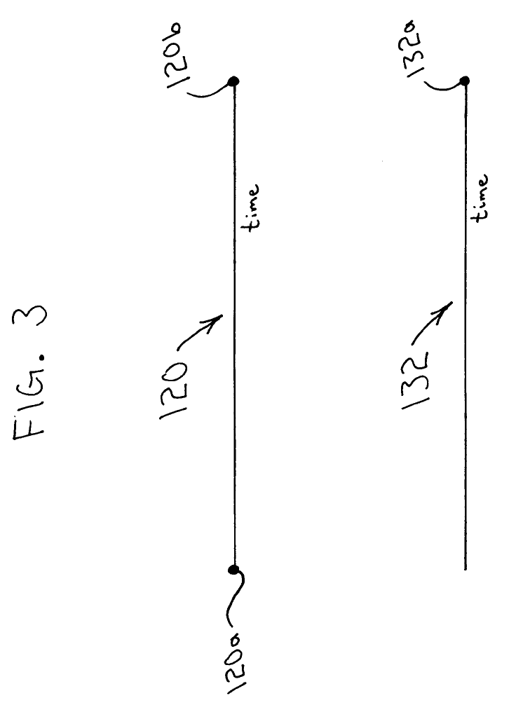

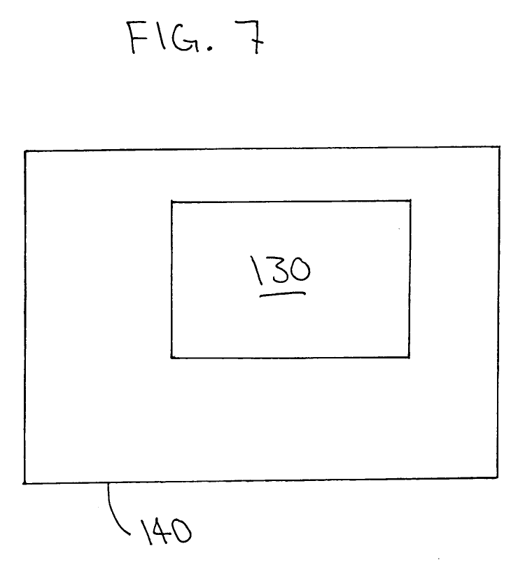

After the product 110 is sold to the consumer 20, or concurrently therewith, the company 10 provides the consumer 20 with audio data 130 and indicates that the audio data 130 is provided to the consumer 20 by the company 10. This is represented in FIG. 1 at S5 and S6. The audio data 130 is compatible with an audio device 140 (FIG. 7) and has a predetermined timespan 132 that corresponds to the predetermined period of time 120 (FIGS. 3 through 6). It is preferred that the audio data 130 includes information about the product 110 as well as entertainment selections such as music, educational pieces, audio books, comedy, etc. The consumer may choose a content of the audio data 130 before the company provides the consumer 20 with the audio data 130 (represented in FIG. 1 at S4), or the company 10 may provide standard content to all consumers 20. If the consumer 20 chooses the content of the audio data 130, he may either choose a genre (such as rock-and-roll, country, jazz, motivational, etc.) or actual selections to be included in the audio data 130, and he may also select a language for the content of the audio data 130, such as English, Spanish, or Chinese, for example. This selection may take place various ways, such as by filling out and returning a reply card that came with the product 110, or by entering information online at a predetermined website. The company 10 may indicate that the audio data 130 is provided to the consumer 20 by the company 10 in various ways, including labeling the audio data 130 or including the information in the audio data 130. This is meant to encourage brand loyalty to the company 10.

The audio data 130 may be in almost any format, including wav, MP3, RealAudio, Windows Media Audio (WMA), and others, and the audio data 130 may be provided to the consumer 20 in various ways, including on CD, cassette tape, video tape, DVD, a USB memory drive, a floppy disc, over the internet, through a broadcast that is saved to a memory device, and others. The audio device 140 may be a CD player; a cassette tape player; a player for digitally compressed audio data files; a receiver for AM, FM, or satellite signals that has a memory storage unit and software to recognize a beginning and an end of the broadcast; or another device that plays the audio data 130.

For further encouraging brand loyalty, the company 10 may provide the audio device 140 to the consumer 20 and indicate that the audio device 140 is provided to the consumer 20 by the company 10. This is represented in FIG. 1 at S2 and S3. This may be easily done by labeling the audio device 140 with the company's name or with the name of the product 110, or another method of indication may be used. The company 110 may also refrain from charging the consumer 20 for providing the consumer 20 with the audio data 130 or the audio device 140 to encourage brand loyalty.

At step S7, after the consumer 20 has the product 110, the audio data 130, and the audio device 140, the company 10 instructs the consumer to begin playing the audio data 130 on the audio device 140 at the beginning 120a of the predetermined period of time 120. The company 10 informs the consumer that an end 132a of the audio data's predetermined timespan 132 signals the conclusion 120b of the predetermined period of time 120 at step S8 (FIG. 1). Steps S7 and S8 are preferably accomplished through written materials, though other means of communication may be used.

At step S9, in accordance with these instructions, the consumer initializes the playing of the audio data 130 on the audio device 140 at the beginning 120a of the predetermined period of time 120 and allows the audio device 140 to play the audio data 130 for the predetermined timespan 132. At step S10, the end of the predetermined timespan 132 signals the conclusion of the predetermined period of time 120, or in other words, when the audio device 140 stops playing the audio data 130, the consumer 20 has reached the conclusion of the predetermined period of time 120.

The company 10 may then periodically provide the consumer 20 with additional audio data 130 having the predetermined timespan 120 to encourage brand loyalty and repurchasing of the product 110. This is represented in FIG. 1 at S11. The consumer 20 may choose the content of the additional audio data 130, or the company may send all consumers 20 standardized audio data 130. Notably, the internet provides a convenient forum for the consumer 20 to choose the content of the additional audio data 130, should this be desired. This would also allow the company 10 additional opportunities to communicate to the consumer 20 and encourage brand loyalty while the consumer accesses the internet to choose the content of the additional audio data 130.

It is understood that while certain forms of this invention have been illustrated and described, it is not limited thereto except insofar as such limitations are included in the following claims and allowable functional equivalents thereof.

What is claimed is as follows:

1. A method for signaling a conclusion of a predetermined period of time while encouraging brand loyalty to a company, said method comprising:
the company selling a product to a consumer, said product requiring the tracking of the predetermined period of time;
the company providing said consumer with audio data having a predetermined timespan corresponding to the predetermined period of time, said audio data being compatible with an audio device;
the company indicating that said audio data is provided to said consumer by the company;
said consumer initializing the playing of said audio data on said audio device at a beginning of the predetermined period of time;
said audio device playing said audio data for said predetermined timespan; and
wherein an end of said predetermined timespan signals the conclusion of the predetermined period of time.

2. The method as in claim 1, said method further comprising:
the company providing said audio device to said consumer; and
the company indicating that said audio device is provided to said consumer by the company.

3. The method as in claim 2, wherein said audio device is selected from the group consisting of:
a CD player;
a cassette tape player; and
a player for digitally compressed audio data files.

4. The method as in claim 1, wherein said product is a pharmaceutical drug prescribed to be taken by said consumer at preset intervals.

5. The method as in claim 4, wherein said pharmaceutical drug requires the tracking of the predetermined period of time after said pharmaceutical drug is ingested by said consumer for limiting said consumer's activities during the predetermined period of time.

6. The method as in claim 1, wherein said audio data comprises information pertaining to said product.

7. The method as in claim 6, wherein said audio data further comprises an entertainment selection.

8. The method as in claim 1, wherein said audio data comprises music.

9. The method as in claim 1, said method further comprising said consumer choosing a content of said audio data before the company provides said consumer with said audio data.

10. The method as in claim 1, said method further comprising periodically providing said consumer with additional audio data having said predetermined timespan.

11. A method for enabling a conclusion of a predetermined period of time to be signaled while encouraging brand loyalty to a company, said method comprising:
selling a product to a consumer, said product requiring the tracking of the predetermined period of time;
providing said consumer with audio data having a predetermined timespan corresponding to the predetermined period of time, said audio data being compatible with an audio device;
indicating that said audio data is provided to said consumer by the company;
instructing said consumer to begin playing said audio data on said audio device at a beginning of the predetermined period of time; and
instructing said consumer that an end of said audio data signals the conclusion of the predetermined period of time.

12. The method as in claim 11, said method further comprising:
providing said audio device to said consumer; and
indicating that said audio device is provided to said consumer by the company.

13. The method as in claim 12, wherein said audio device is selected from the group consisting of:
a CD player;
a cassette tape player; and
a player for digitally compressed audio data files.

14. The method as in claim 11, wherein:
said product is a pharmaceutical drug prescribed to be taken by said consumer at preset intervals;
said pharmaceutical drug requires the tracking of the predetermined period of time after said pharmaceutical drug is ingested by said consumer for limiting said consumer's activities during the predetermined period of time; and
said beginning of the predetermined period of time corresponds to when said pharmaceutical drug is ingested by said consumer.

15. The method as in claim 1 1, wherein:
said product is a hair treatment; and
said beginning of the predetermined period of time corresponds to a point in time when said hair treatment is placed on hair.

16. The method as in claim 1 1, wherein:
said product is a cookbook; and
said beginning of the predetermined period of time corresponds to a point in time when food begins cooking.

17. The method as in claim 11, wherein said audio data comprises information pertaining to said product.

18. The method as in claim 1 1, said method further comprising receiving a choice from said consumer for a content of said audio data before providing said consumer with said audio data.

19. The method as in claim 11, said method further comprising periodically providing said consumer with additional audio data having said predetermined timespan.

20. The method as in claim 11, wherein the company does not charge said consumer for providing said consumer with said audio data.
